(19) United States
(12) Patent Application Publication
(10) Pub. No.: US 2012/0066712 A1
(43) Pub. Date: Mar. 15, 2012

(54) SYSTEM AND METHOD FOR NOTIFYING ADVERTISERS OF AVAILABLE TARGETED ADVERTISING SLOTS

(76) Inventor: Jennifer Schultz, Johns Creek, GA (US)

(21) Appl. No.: 12/880,609

(22) Filed: Sep. 13, 2010

(51) Int. Cl. H04N 7/025; G06Q 30/00

(52) U.S. Cl. 725/32; 705/14.49

(57) ABSTRACT

An advertising slot notification (ASN) system and method for automatically notifying an advertiser that a desired targeted advertising slot meeting an advertiser-defined preference is available. The advertiser-defined preference, such as programming content associated with the advertising slot, is input to a comparison unit together with information on available advertising slots and associated programming content. The comparison unit compares the preference with the available slots and associated information to identify a slot meeting the advertiser-defined preference. A notification server automatically notifies the advertiser that the desired advertising slot is available. The system may also include an advertising slot labeling (ASL) system for providing to the comparison unit, an advertisement slot label for each available advertising slot, wherein the label indicates an effectiveness level for each advertising slot when used to present different kinds of advertisements.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to television (TV) delivery systems. More particularly, and not by way of limitation, the present invention is directed to a system and method for notifying advertisers of available targeted advertising slots.

Advertisers are looking for ways to get consumers to pay attention to their advertising. One way is to use targeted advertising. Targeted advertisements relying on demographic information such as age, gender, location, and the like are generally thought to be more engaging or interesting to a viewer than non-targeted ads. Advertisers employ a variety of methods for targeting advertisements to viewers. One method of targeting advertisements is to show the advertisements during TV shows that would be of interest to the same type of viewers who would purchase the advertised product or service.

Advertisers who wish to advertise in a Video On Demand (VOD) or broadcast TV environment manually place a bid for an available advertising slot (ad avail) indicating their interest and the amount of money they are willing to pay for the ad avail. The manual bidding process, however, can be slow, inefficient, and frustrating to the advertisers. Often, an advertiser is not made aware of an ad avail appropriate for their advertisement until the ad avail is already taken by another bidder.

### BRIEF SUMMARY OF THE INVENTION

The present invention provides an automated method of notifying an advertiser of available targeted advertising slots (ad avails) that meet advertiser-defined criteria. The criteria may comprise ad/content-mapping rules for the type of ad avails that are of interest to the advertiser. For example, a restaurant popular with children might want to be notified of ad avails near cartoons or children's shows. The mapping rules may be input to an Ad Slot Labeling (ASL) server, which communicates with a system that monitors ad avails in the TV delivery system. When an ad avail arrives in the TV delivery system that matches the advertiser's criteria, a notification server automatically notifies the advertiser, and the advertiser can then bid on the ad avail if desired.

In one embodiment, the present invention is directed to a computer-controlled method of notifying an advertiser that a desired targeted advertising slot meeting an advertiser-defined preference is available. The method includes the steps of receiving by a comparison unit, information regarding the advertiser-defined preference; receiving by the comparison unit, information regarding available advertising slots and associated information relating to the advertiser-defined preference; identifying by the comparison unit, the desired advertising slot by identifying an available advertising slot that meets the advertiser-defined preference; and automatically, sending a notification to the advertiser notifying the advertiser that the desired advertising slot is available. The advertiser-defined preference may be, for example, a type of programming content that the advertiser prefers to be presented near the desired advertising slot. In this case, the comparison unit receives scheduling information for the available advertising slots and for programming content scheduled to be presented at or near the time of each available advertising slot.

In a further related embodiment, the comparison unit receives from an advertising slot labeling system, an advertisement slot label for each available advertising slot. The label indicates an effectiveness level for each advertising slot when used to present different kinds of advertisements. In this case, the method further comprises the steps of receiving by the advertising slot labeling system, market research data indicating the effectiveness of different kinds of advertising when presented with different kinds of programming content; receiving by the advertising slot labeling system, multimedia content metadata that corresponds to the programming content; comparing the received market research data with the received multimedia content metadata; and selecting one or more advertisement slot labels for one or more advertisement slots of the multimedia content based on the comparison of the received market research data and the received multimedia content metadata.

In another embodiment, the present invention is directed to an advertising slot notification (ASN) system for notifying an advertiser that a desired targeted advertising slot meeting an advertiser-defined preference is available. The ASN system includes an advertiser preference database for storing the advertiser-defined preference; means for obtaining information regarding available advertising slots and associated information relating to the advertiser-defined preference; a comparison unit for comparing the advertiser-defined preference with the available advertising slots and associated information to identify the desired advertising slot meeting the advertiser-defined preference; and an advertising slot notification server for automatically sending a notification to the advertiser notifying the advertiser that the desired advertising slot is available.

In a further related embodiment, the system also includes an advertising slot labeling (ASL) system for providing to the comparison unit, an advertisement slot label for each available advertising slot, wherein the label indicates an effectiveness level for each advertising slot when used to present different kinds of advertisements.

The present invention benefits advertisers by automatically notifying them when advertisement slots matching specific criteria (such as content-ad pairings) arrive in the system. Using the ASL system with the ASN system provides more accurate criteria matching, but even without the advertising slot labels, the invention provides a way to promote ad slots to an advertiser, and gives advertisers an edge on knowing when the “perfect” ad slot arrives.

### BRIEF DESCRIPTION OF THE SEVERAL VIEWS OF THE DRAWING

In the following section, the invention will be described with reference to exemplary embodiments illustrated in the figures, in which:

FIG. 1 is a simplified block diagram of a first exemplary embodiment of the system of the present invention;

FIG. 2 is a flow chart illustrating the steps of a first exemplary embodiment of the method of the present invention;

FIG. 3 is a simplified block diagram of a second exemplary embodiment of the system of the present invention; and

FIG. 4 is a flow chart illustrating the steps of a second exemplary embodiment of the method of the present invention.

### DETAILED DESCRIPTION OF THE INVENTION

The present invention provides an automated system and method for notifying an advertiser of available targeted advertising slots (ad avails) that meet advertiser-defined criteria.

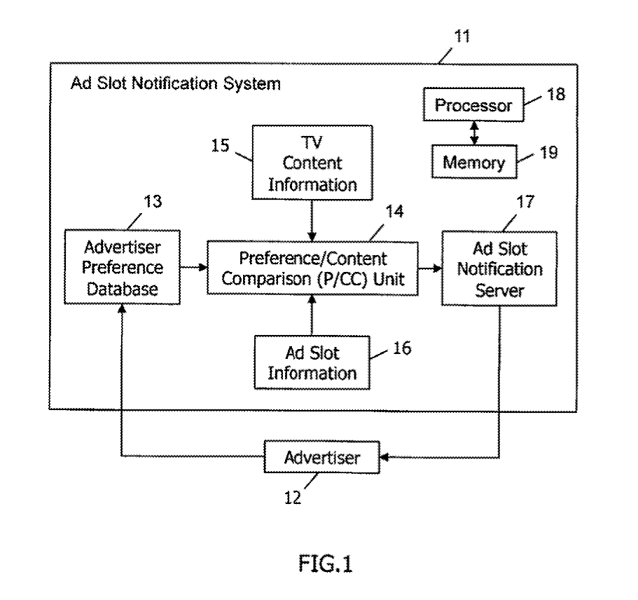

FIG. 1 is a simplified block diagram of a first exemplary embodiment of the Ad Slot Notification (ASN) system 11 of the present invention. An advertiser 12 inputs ad slot preferences into an advertiser preference database 13. For example, the advertiser may prefer an ad slot in or close to a children's program, an adventure show, or a sports show. The preference may be generic (e.g., sports show), semi-specific (e.g., college football), or specific (e.g., a particular college football game). The preferences may also include such parameters as the time of day, the day of the week, the channel or network, and the like. A preference/content comparison (P/CC) unit 14 retrieves the preferences from the database and compares them with TV content information 15 and available ad slot information 16. When an ad slot matching the preferences is found, the P/CC unit sends information about the matching ad slot to an ad slot notification server 17. The ad slot notification server then sends a notification to the advertiser informing the advertiser of the matching ad slot. In one embodiment, operation of the ASN system may be controlled by a processor 18 executing computer program instructions stored on a memory 19.

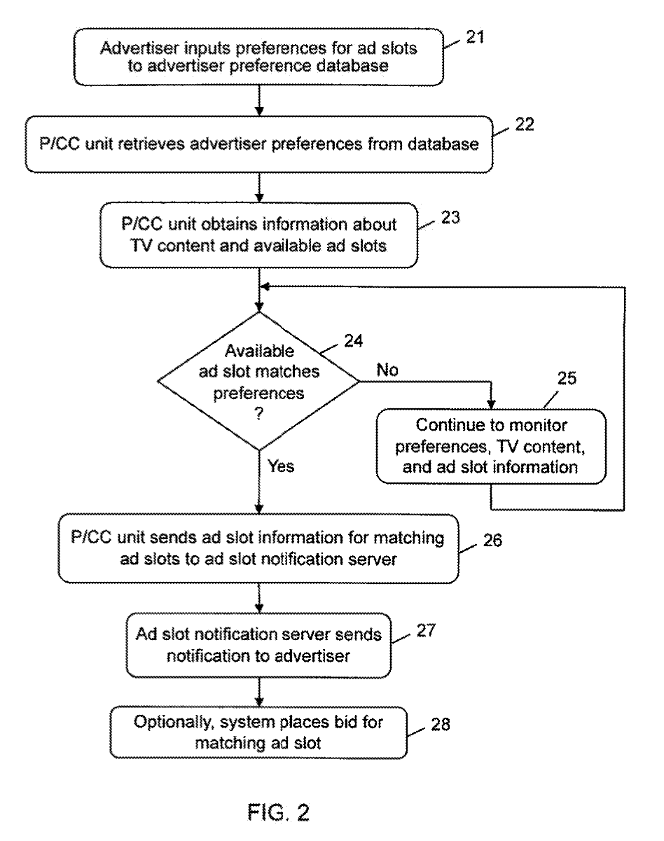

FIG. 2 is a flow chart illustrating the steps of a first exemplary embodiment of the method of the present invention. At step 21, the advertiser 12 inputs the ad slot preferences into the advertiser preference database 13. At step 22, the P/CC unit 14 retrieves the preferences from the database. At step 23, the P/CC unit compares the preferences with the TV content information 15 and the available ad slot information 16. At step 24, the P/CC unit determines whether an available ad slot match the preferences. If not, the method moves to step 25 where the P/CC unit continues to monitor the advertiser's preferences, the TV content information, and the available ad slot information. The method returns to step 24 until a matching ad slot is found.

When a matching ad slot is found at step 24, the method moves to step 26 where the P/CC unit sends information about the matching ad slot to the ad slot notification server 17. At step 27, the ad slot notification server then sends a notification to the advertiser informing the advertiser of the matching ad slot. In an optional step 28, the ASN system 11 may automatically place a bid for a matching ad slot. Such action may be activated or deactivated, for example, by an advertiser preference in the database 13.

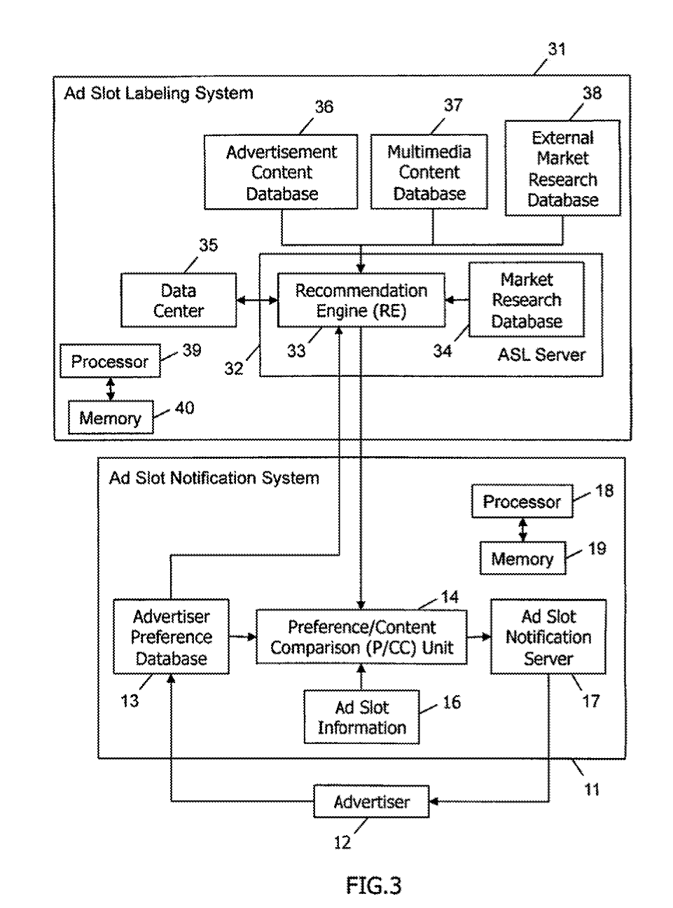

FIG. 3 is a simplified block diagram of a second exemplary embodiment of the system of the present invention. In this embodiment, the Ad Slot Notification (ASN) system 11 interfaces with an Ad Slot Labeling (ASL) system 31 to obtain the TV content information 15 and ad slot information 16 (FIG. 1). The ASL system automatically labels advertisements and advertising slots appropriately in regards to what television content surrounds the slot, to maximize the effectiveness of the advertisement. While existing methods of selecting advertisements are based solely on demographics (e.g., advertisements are shown based on the age, gender, location, and other statistics gathered regarding the consumer), the ASL system provides a much more comprehensive and effective means of selecting advertisements.

Using existing or newly gathered statistical data on consumer responses to various types of advertisements after various types of content, the ASL system 31 labels advertising slots with information regarding the types of advertisements that would be most effective when shown before, during, or after the type of show scheduled for that time period. For example, market research data may show that “humorous” advertisements are most effective after cooking shows, while “serious” advertisements work best before and after dramas. Advertisements may also be labeled based on their content (food, toys, life insurance, etc.), method (humor, celebrities, etc.), length, or other criteria. A particular slot may have several types of labels, listed in order of researched effectiveness. Once advertising slots have been automatically labeled, appropriate (human labeled) ads may be added to maximize their effectiveness. Such advertisements may have several labels associated with them (for instance, an ad can be labeled as “funny” as well as “food”).

Ad labeling immediately provides some measure of guarantee of advertising effectiveness, while being able to fold in data regarding demographics. For example, an advertisement labeled ‘toy’ might be most effective after cartoons, but additional labels could increase its effectiveness by providing information that can be used to demographically target the advertisement. For example, an advertisement labeled as ‘toy’ ‘funny’ ‘fun’ might be most effective early in the day when children are alone while watching the advertisements, while an advertisement labeled ‘toy’ ‘serious’, ‘value’ might work better later in the day when parents are more likely to be watching the advertisements with their children. Better targeted ads provide more return for advertisers.

The ASL system 31 includes an ASL server 32, which includes a Recommendation Engine (RE) 33 and a market research database 34 for storing market research data indicating the effectiveness of different kinds of advertising when presented with different kinds of programming content. Also connected to the RE are a data center 35, an advertisement content database 36, a multimedia content database 37 for storing multimedia content metadata corresponding to the programming content, and an optional external market research data source 38. In one embodiment, operation of the ASL system may be controlled by a processor 39 executing computer program instructions stored on a memory 40.

The RE 33 receives market research data, multimedia content metadata, and advertisement data and compares the received market research data with the received multimedia content metadata. The RE then selects one or more ASL labels for one or more advertisement slots based on the comparison of the received market research data and the received multimedia content metadata. The RE outputs the ASL labels indicating an effectiveness level for each advertising slot when used to present different kinds of advertisements. The RE provides the ASL labels to the P/CC unit 14 in the ASN system 11, which uses this additional information to optimize the process of matching available advertising slots to the advertiser-defined preferences. When the P/CC unit identifies a matching advertising slot, the P/CC unit sends information about the advertising slot to the ad slot notification server 17. The ad slot notification server then sends a notification to the advertiser 12 informing the advertiser of the matching advertising slot. The advertiser can then bid on the advertising slot, or the ASN system 11 may automatically place a bid for a matching slot. Automated ad insertion provides higher quality advertisement placement while eliminating manual advertisement placement.

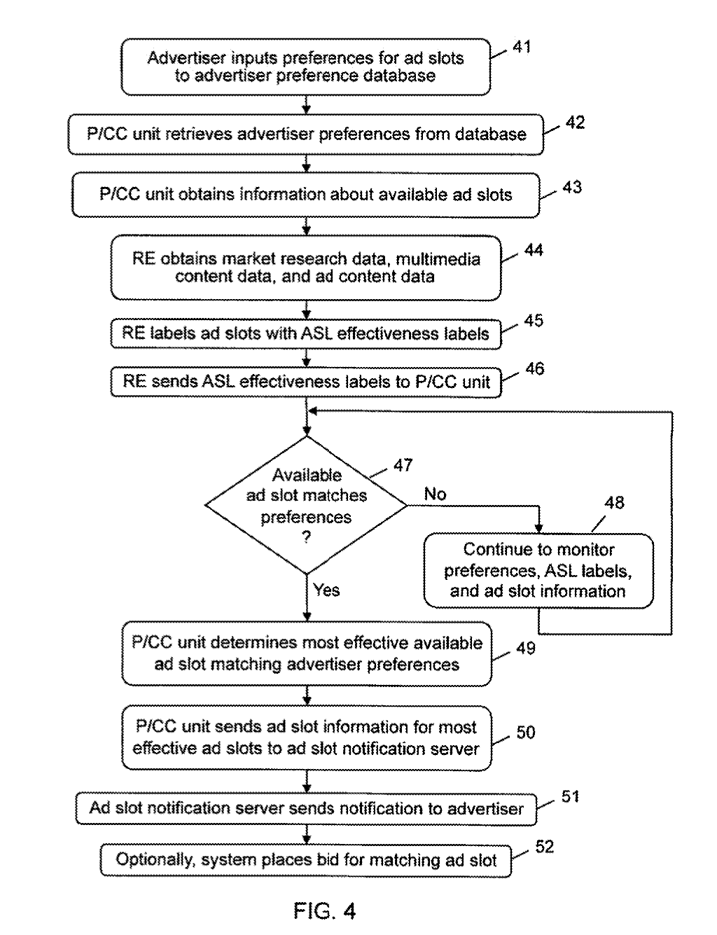

FIG. 4 is a flow chart illustrating the steps of a second exemplary embodiment of the method of the present invention. At step 41, the advertiser 12 inputs the ad slot preferences into the advertiser preference database 13. At step 42, the P/CC unit 14 retrieves the preferences from the database. At step 43, the P/CC unit obtains information about the available ad slots 16. At step 44, the RE 33 obtains market research data from the market research database 34 and optionally the external market research database 38, obtains multimedia content data from the multimedia content database 37, and obtains advertisement content data from the advertisement content database 36. At step 45, the RE labels ad slots with ASL effectiveness labels indicating the effectiveness of each ad slot for different kinds of advertisements. At step 46, the RE sends a recommendation to the P/CC unit 14 with the ASL effectiveness labels.

At step 47, the P/CC unit 14 determines whether an available ad slot match the advertiser's preferences. If not, the method moves to step 48 where the P/CC unit continues to monitor the advertiser's preferences, the ASL labels, and the available ad slot information. The method returns to step 47 until a matching ad slot is found. When a matching ad slot is found, the method moves to step 49 where the P/CC unit determines the most effective available ad slot matching the advertiser's preferences. At step 50, the PICC unit sends ad slot information for the most effective ad slots to the ad-slot notification server 17. At step 51, the ad slot notification server then sends a notification to the advertiser informing the advertiser of the matching ad slot. In an optional step 52, the ad slot notification server may automatically place a bid for a matching ad slot. Such action may be activated or deactivated, for example, by an advertiser preference in the database 13.

The ASN system 11, whether used alone or with the ASL system 31, provides an automated system that notifies advertisers that ad slots matching specific criteria (such as content-ad pairings in ASL) have arrived in the system. Using ASL with the ASN system allows more accurate criteria matching, but even without ASL, the invention provides a way to advertise ad slots to an advertiser, and gives advertisers an edge on knowing when the “perfect” ad slot arrives.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A computer-controlled method of notifying an advertiser that a desired targeted advertising slot meeting an advertiser-defined preference is available, the method comprising the steps of:
receiving by a comparison unit, information regarding the advertiser-defined preference;
receiving by the comparison unit, information regarding available advertising slots and associated information relating to the advertiser-defined preference;
identifying by the comparison unit, the desired advertising slot by identifying an available advertising slot that meets the advertiser-defined preference; and
automatically sending a notification to the advertiser notifying the advertiser that the desired advertising slot is available.

2. The method according to claim 1, wherein the advertiser-defined preference is a type of programming content that the advertiser prefers to be presented near the desired advertising slot, and the step of receiving information regarding available advertising slots and information relating to the advertiser-defined preference includes receiving scheduling information for the available advertising slots and for programming content scheduled to be presented at or near the time of each available advertising slot.

3. The method according to claim 2, wherein the programming content is television content.

4. The method according to claim 1, wherein the advertiser-defined preference is an identified program that the advertiser prefers to be presented near the desired advertising slot, and the step of receiving information regarding available advertising slots and information relating to the advertiser-defined preference includes receiving scheduling information for the available advertising slots and for the identified program.

5. The method according to claim 4, wherein the identified program is a television program.

6. The method according to claim 1, wherein the advertiser-defined preference is stored in a database of advertiser preferences, and the step of receiving information regarding the advertiser-defined preference includes retrieving the advertiser-defined preference from the database by the comparison unit.

7. The method according to claim 1, wherein the step of receiving information regarding available advertising slots and associated information relating to the advertiser-defined preference includes receiving from an advertising slot labeling system, an advertisement slot label for each available advertising slot, wherein the label indicates an effectiveness level for each advertising slot when used to present different kinds of advertisements.

8. The method according to claim 7, further comprising the steps of:
receiving by the advertising slot labeling system, market research data indicating the effectiveness of different kinds of advertising when presented with different kinds of programming content;
receiving by the advertising slot labeling system, multimedia content metadata that corresponds to the programming content;
comparing the received market research data with the received multimedia content metadata; and
selecting one or more advertisement slot labels for one or more advertisement slots of the multimedia content based on the comparison of the received market research data and the received multimedia content metadata.

9. The method according to claim 1, further comprising automatically placing a bid for the desired advertising slot.

10. An advertising slot notification system for notifying an advertiser that a desired targeted advertising slot meeting an advertiser-defined preference is available, the system comprising:
an advertiser preference database for storing the advertiser-defined preference;
means for obtaining information regarding available advertising slots and associated information relating to the advertiser-defined preference;
a comparison unit for comparing the advertiser-defined preference with the available advertising slots and associated information to identify the desired advertising slot meeting the advertiser-defined preference; and
an advertising slot notification server for automatically sending a notification to the advertiser notifying the advertiser that the desired advertising slot is available.

11. The system according to claim 10, wherein the advertiser-defined preference is a type of programming content that the advertiser prefers to be presented near the desired advertising slot, and the means for obtaining information includes means for obtaining scheduling information associated with the available advertising slots and with programming content scheduled to be presented at or near the time of each available advertising slot.

12. The system according to claim 11, wherein the programming content is television content.

13. The system according to claim 10, wherein the advertiser-defined preference is an identified program that the advertiser prefers to be presented near the desired advertising slot, and the means for obtaining information includes means for obtaining scheduling information associated with the available advertising slots and with the identified program.

14. The system according to claim 13, wherein the identified program is a television program.

15. The system according to claim 10, further comprising an advertising slot labeling system for providing to the comparison unit, an advertisement slot label for each available advertising slot, wherein the label indicates an effectiveness level for each advertising slot when used to present different kinds of advertisements.

16. The system according to claim 15, further comprising:
means for receiving by the advertising slot labeling system, market research data indicating the effectiveness of different kinds of advertising when presented with different kinds of programming content;
means for receiving by the advertising slot labeling system, multimedia content metadata that corresponds to the programming content;
means within the advertising slot labeling system for comparing the received market research data with the received multimedia content metadata; and
means for selecting one or more advertisement slot labels for one or more advertisement slots of the multimedia content based on the comparison of the received market research data and the received multimedia content metadata.

17. The system according to claim 10, wherein the advertising slot notification server automatically places a bid for the desired advertising slot.
